(19) United States
(12) Patent Application Publication
(10) Pub. No.: US 2009/0327335 A1
(43) Pub. Date: Dec. 31, 2009

(54) Systems and Methods For Generating Vendor-Independent Computer-Aided Diagnosis Markers

(75) Inventors: Mohammed Abdul Wahab, Carol Stream, IL (US); Medhi Venon, Whitefish Bay, WI (US); Kengo Baba, Evanston, IL (US); Amarnath Reddy Chavva, Bangalore (IN)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 12/164,980

(22) Filed: Jun. 30, 2008

(51) Int. Cl. G06F 17/30

(52) U.S. Cl. 707/102; 707/E17.044

(57) ABSTRACT

Certain embodiments of the present invention provide a system for vendor-independent computer-aided diagnosis (CAD) marker generation including a parser adapted to parse CAD marker data into parsed data and a marker generator adapted to generate generic marker data based on the parsed data and a configuration file. The generic marker data includes a set of point pairs.

### BACKGROUND OF THE INVENTION

The present invention generally relates to computer-aided diagnosis and imaging informatics. In particular, the present invention relates to systems and methods for generating vendor-independent computer-aided diagnosis markers.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that is stored in a medical information system.

PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a lesion in x-ray images of a patient's lungs. As another example, a radiologist may diagnose a tumor in a mammography image.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

Computer-aided diagnosis (CAD) of image data may be utilized by practitioners to aid in reading medical images. CAD software in CAD processing units and/or an advanced analysis workstation may identify features and potential abnormalities and/or anomalies in medical images to bring to the attention of the practitioner. CAD markers indicating these features, abnormalities, and/or anomalies on the image can then be generated. Such markers may be used as an aid in the detection of a region of interest for the practitioner to examine. For example, CAD software and/or an advanced analysis workstation may overlay arrows pointing out a potential abnormality in the image. In addition, CAD software and/or an advanced analysis workstation can generate a report of the identified features, abnormalities, and/or anomalies. The practitioner may then review the marked images and/or reports prior to making a final diagnosis.

CAD markers are typically stored according to the Digital Imaging and Communications in Medicine (DICOM) Structured Reporting (SR) format. However, DICOM does not standardize the shape of the CAD markers and it is left up to the vendor to define the specifications for each marker. The vendor also defines algorithms that can be used to draw a particular marker. In current systems, PACS vendors use these specifications and algorithms to create the computational logic to draw the vendor-specific markers.

The shape, characteristics, and the meaning of CAD markers may vary between vendors. In addition, the shape and characteristics may vary between CAD software versions from the same vendor and the shapes might be localized for some regions while some shapes might not be appropriate for display. These problems are currently addressed by implementing separate DICOM SR parsers for each vendor and version. Hence, for each CAD vendor/version, PACS vendors must write vendor/version-specific CAD translators as defined by the vendor algorithms. This results in implementation effort to support each vendor/version; high turn around time for a specific vendor/version; complex code and high maintenance with many DICOM SR parsers; and a high risk of inconsistency misleading the end users.

### BRIEF SUMMARY OF THE INVENTION

Certain embodiments of the present invention provide a system for vendor-independent computer-aided diagnosis (CAD) marker generation including a parser adapted to parse CAD marker data into parsed data and a marker generator adapted to generate generic marker data based on the parsed data and a configuration file. The generic marker data includes a set of point pairs.

Certain embodiments of the present invention provide a method for vendor-independent computer-aided diagnosis (CAD) marker generation including receiving CAD marker data at a parser, parsing the received CAD marker data into parsed data at the parser, and generating generic marker data based on the parsed data and a configuration file at a marker generator. The generic marker data includes a set of point pairs.

Certain embodiments of the present invention provide a computer-readable medium including a set of instructions for execution on a computer, the set of instructions including a parser routine configured to parse CAD marker data into parsed data and a marker generator routine configured to generate generic marker data based on the parsed data and a configuration file. The generic marker data includes a set of point pairs.

### BRIEF DESCRIPTION OF SEVERAL VIEWS OF THE DRAWINGS

FIG. 1 illustrates an exemplary computer-aided diagnosis marker.

FIG. 2 illustrates a system for vendor-independent computer-aided diagnosis marker generation in accordance with an embodiment of the present invention.

FIG. 3 illustrates a system for vendor-independent computer-aided diagnosis marker generation in accordance with an embodiment of the present invention.

FIG. 4 illustrates an exemplary configuration file for vendor-independent computer-aided diagnosis marker generation in accordance with an embodiment of the present invention.

FIG. 5 illustrates a flow diagram for a method for vendor-independent computer-aided diagnosis marker generation according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a universal marker parser for drawing CAD markers by using point-to-point line/curve connections instead of an algorithm defined by a vendor. Certain embodiments eliminate vendor-specific CAD translators. Certain embodiments provide quick support for different markers from various vendors, versions, and/or regions. Certain embodiments provide savings in development time and cost. Certain embodiments allow a simplification of the workstation software application with lesser safety or major risk problems.

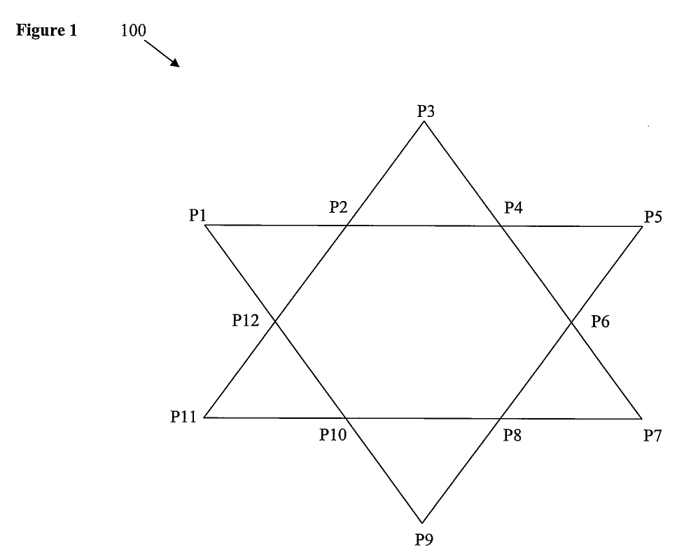

FIG. 1 illustrates an exemplary computer-aided diagnosis marker 100. More particularly, the CAD marker 100 is used for Mammo calcification. The vendor may specify that the shape be drawn using lines (P1, P5), (P5, P9), (P9, P1), (P3, P7) (P7, P11) and (P11, P3). Although this is a simple way to draw the CAD marker 100, this approach requires knowledge of the shape. That is, drawing the shape is dependent on the display generator knowing the vendor's specification for the marker.

In contrast, certain embodiments of the present invention provide a universal marker parser for drawing CAD markers by using point-to-point line/curve (with slope) connections instead of the algorithm provided by the vendors. That is, a series of points to be connected using lines and/or curves is provided to the marker renderer. This approach eliminates vendor-specific CAD translators. For example, for the CAD marker 100 illustrated in FIG. 1, certain embodiments would use the approach of drawing the shape as a sequence of point-to-point lines between points (P1, P2, P3, P4, P5, P6, P7, P8, P9, P10, P11, P12, P1) (and then, similarly, a sequence of point-to-point lines for the interior lines as well). Thus, while there is a larger number of lines to be drawn, by converting a shape into a sequence of point-to-point elements using a configuration file removes vendor dependency. In certain embodiments, for example, the universal marker parser for drawing CAD markers can also parse information about the characteristics of the lines/curves (e.g., the thickness, background, and color), and information about the marker such as color fill and additional information to be displayed with the marker such as vendor name, for example.

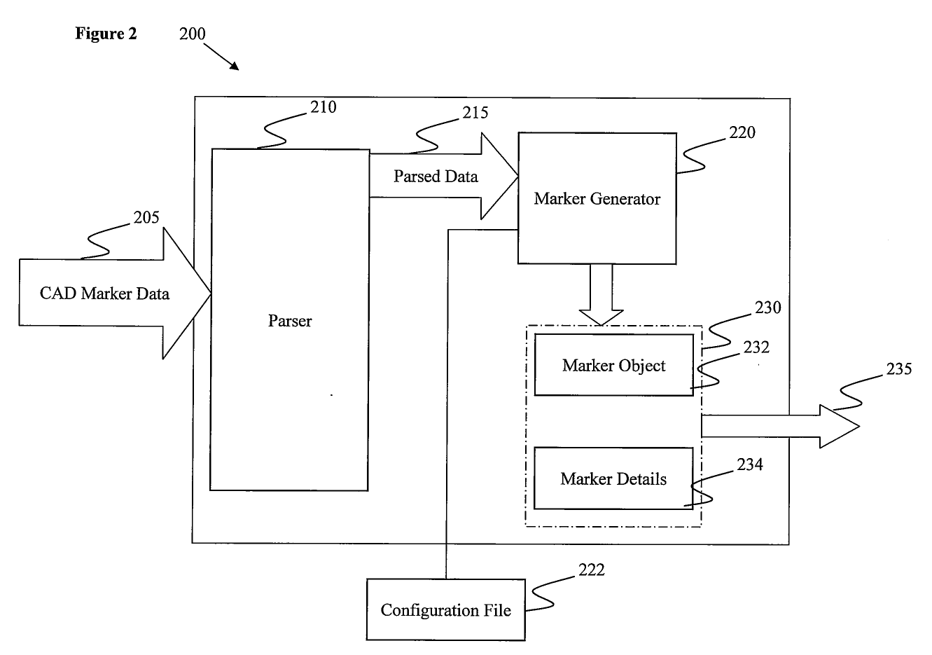

FIG. 2 illustrates a system 200 for vendor-independent computer-aided diagnosis marker generation in accordance with an embodiment of the present invention. The system 200 includes a parser 210 and a marker generator 220. The parser 210 is in communication with the marker generator 220. The system 200 may be part of a PACS, for example.

In operation, the parser 210 received CAD marker data 205 and parsed it to generate parsed data 215. The marker generator 220 received the parsed data 215 and based on a configuration file 222 generates generic marker data 230. The generic marker data 230 may then be output 235 to a workstation for rendering and display.

The parser 210 is adapted to receive CAD marker data 205. In certain embodiments, for example, the CAD marker data 205 can be data representing aspects of an image to draw a healthcare practitioner's attention to, and can be from CAD software, an analysis module on a remote server, and/or a vendor workstation. In certain embodiments, for example, the CAD marker data 205 can be in Structure Reporting for Medical Evidence format and/or DICOM SR format.

The parser 210 is adapted to parse the received CAD marker data 205. The CAD marker data 205 is parsed into parsed data 215. The parsed data 215 is then communicated to the marker generator 220. In certain embodiments, for example, the parser 210 may include and/or utilize a Protocol Parser to parse the CAD marker data 205. In certain embodiments, for example, the parser 210 may include and/or utilize a DICOMR SR parser such as MergeCom to parse the CAD marker data 205.

The marker generator 220 is adapted to generate generic marker data 230 based on the parsed data 215. The marker generator 220 may also utilize a configuration file 222 to generate the generic marker data 230 based on the parsed data 215.

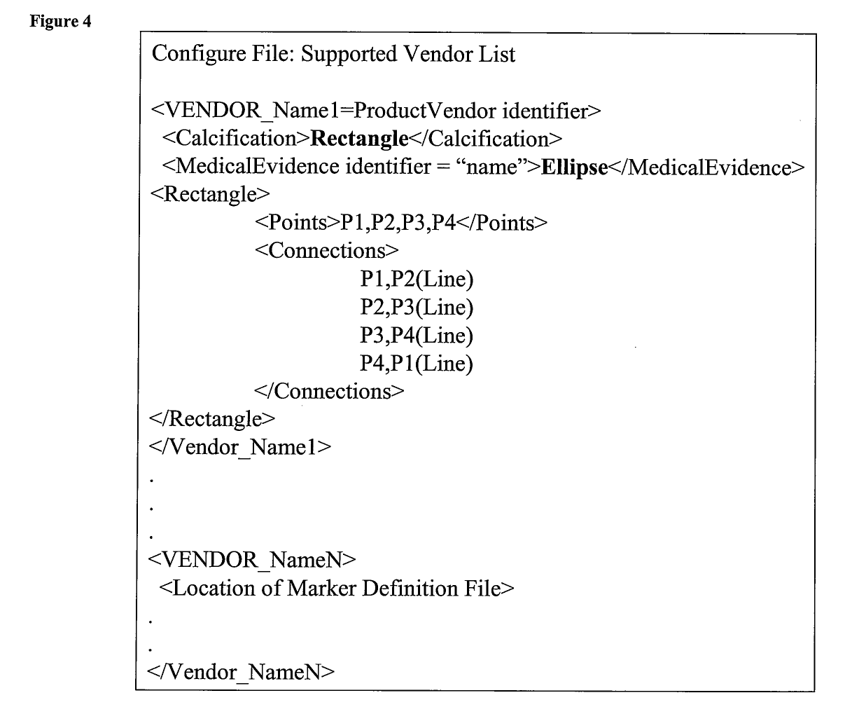

The configuration file 222 includes rules defining how the generic marker data 230 should be generated from the parsed data 215. For example, the configuration file 222 may include supported vendor names. The vendor names may be identified in a tag, such as a DICOM SR tag, for example, or from a database, for example. As another example, the configuration 222 may include details about how the parsed data 215 should be interpreted. In certain embodiments, for example, data in a configuration file 222 can include: vendor name, version number of the CAD, name of the shape, what the shape represents (e.g. mass or calcification in mammography), details about the shape of the marker in points, lines and curves with slope, details about the characteristics of the marker (e.g., thickness, color, position of lines/curves in a plane—e.g., front of another line or back of another line), color fill of the shape, and/or any additional information to aid the drawing of the marker. FIG. 4 illustrates an exemplary configuration file for vendor-independent computer-aided diagnosis marker generation in accordance with an embodiment of the present invention.

The generic marker data 230 includes a set of point pairs which may be used to draw a vendor-independent CAD marker on an image. That is, the generic marker data 230 identifies a series of points that are to be connected using lines and/or curves. This series of points may thus be used to define any type of shape. Processing the series of points may be done independently of the CAD software vendor that provided the input CAD marker data 205. The generic marker data 230 may also include information about the characteristics of the lines/curves. For example, the thickness, background, and color. The generic marker data 230 may also include information about the marker such as color fill and additional information to be displayed with the marker such as vendor name.

In certain embodiments, the generic marker data 230 includes a marker object 232. The marker object 232 may be utilized by other applications, for example. In certain embodiments, for example, the marker object 232 can be a Java marker object, and can be utilized by other Java applications. In certain embodiments, for example, the generic marker data 230 can include marker details 234 in XML format, comma separated values format, text format, and/or binary format. In certain embodiments, for example, the marker details 234 can be utilized by third-party applications, for example. In certain embodiments, for example, the marker details 234 can be utilized for debugging purposes.

The generic marker data 230 is then output 235. The output generic marker data 235 may then be used by another application or subsystem to render the marker, for example.

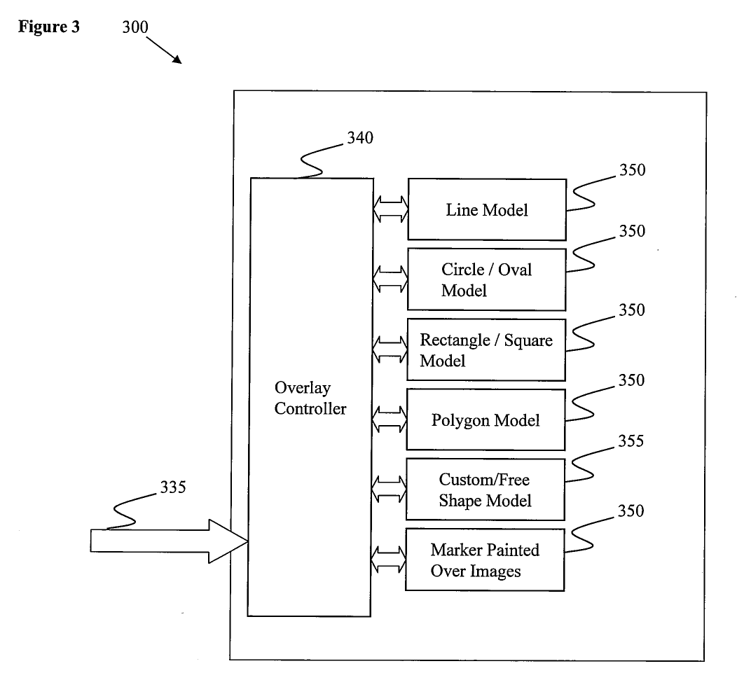

FIG. 3 illustrates a system 300 for vendor-independent computer-aided diagnosis marker generation in accordance with an embodiment of the present invention. The system 300 includes a controller 340 and one or more models 350. The controller 340 is in communication with the models 350. In certain embodiments, for example, the controller 340 can be configured to output graphics and/or other CAD data (e.g., a metric, a color filter, an overlay) to be displayed. The system 300 may be part of a PACS workstation, for example.

In operation, the controller 340 draws markers on an image to be displayed based on the models 350. Based on generic marker data 335 received by the controller 340, the controller 340 may utilize the free shape model 355 to draw markers on the image data.

The controller 340 is adapted to received generic marker data 335. The generic marker data 335 may be similar to the output generic marker data 235, discussed above, for example.

The controller 340 is adapted to draw graphics on an image to be displayed to a user. For example, the controller 340 may draw CAD makers similar to the CAD marker 100, discussed above, for example, based on the received generic marker data 335. The controller 340 may draw the graphics based at least in part on image orientation, size, and scaling, for example.

The controller 340 is adapted to draw the graphics using one or more of the models 350. In certain embodiments, the controller 340 is an RA1000 overlay controller.

The models 350 may be utilized to draw graphics on an image to be displayed to a user. For example, the system 300 may include a line model, a circle/oval model, a rectangle/square model, and/or a polygon model.

Certain embodiments of the present technology include a model that is a custom/free shape model 355. The custom/free shape model 355 is adapted to draw a sequence of point-to-point lines/curves (with slope) to draw a CAD marker. Thus, the controller 340 may process the point pairs in the generic marker data 335 using the custom/free shape model 355 to draw the marker. In certain embodiments, the custom/free shape model 355 may utilize one or more other models 350. For example, the custom/free shape model 355 may utilize a line model 350. In certain embodiments, for example, a rectangle/square model can be used in connection with a circle/oval model. In such an embodiment, a square can be depicted with an oval therein, for example.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a display workstation or one or more dedicated processors.

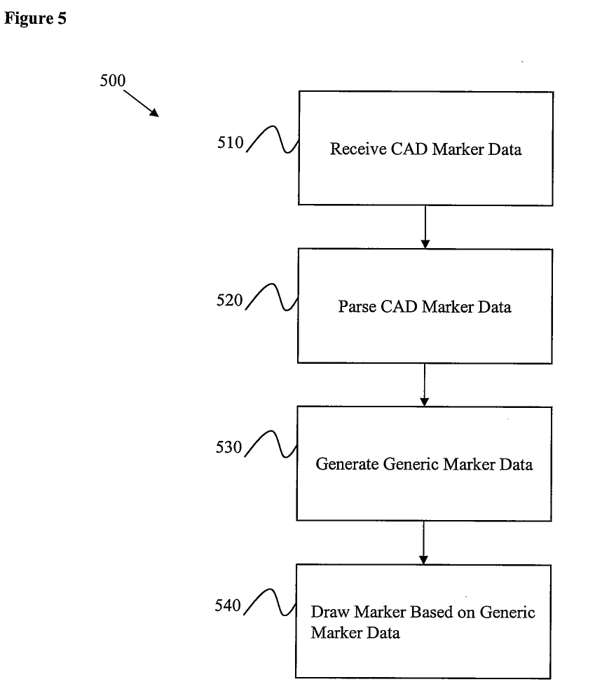

FIG. 5 illustrates a flow diagram 500 for a method for vendor-independent computer-aided diagnosis marker generation according to an embodiment of the present invention. The method includes the following steps, which will be described below in more detail. At step 510, CAD marker data is received. At step 520, the CAD marker data is parsed. At step 530, generic marker data is generated. At step 540, a marker is drawn based on the generic marker data. The method is described with reference to elements of systems described above, but it should be understood that other implementations are possible.

At step 510, CAD marker data is received. The CAD marker data may be similar to the CAD marker data 205, discussed above, for example. The CAD marker data may be received at a parser similar to the parser 210, discussed above, for example. The CAD marker data is data from CAD software representing aspects of an image to draw a healthcare practitioner's attention to. In certain embodiments, for example, the CAD marker data may be in DICOM SR format, for example.

At step 520, the CAD marker data is parsed. The CAD marker data may be the CAD marker data received at step 510, discussed above, for example. The CAD marker data may be parsed by a parser similar to the parser 210, discussed above, for example. In certain embodiments, for example, a DICOMR SR parser such as MergeCom may be used to parse the CAD marker data, for example. The CAD marker data is parsed into parsed data. The parsed data may be similar to the parsed data 215, discussed above, for example.

At step 530, generic marker data is generated. The generic marker data may be similar to the generic marker data 230, discussed above, for example. The generic marker data may be generated by a marker generator similar to the marker generator 220, discussed above, for example. The generic marker data may be generated based on parsed data parsed from the CAD marker data, as discussed at step 520, above, for example.

The generic marker data may be generated based on the parsed data and a configuration file. The configuration file may be similar to the configuration file 222, discussed above, for example.

The generic marker data includes a set of point pairs which may be used to draw a vendor-independent CAD marker on an image. That is, the generic marker data identifies a series of points that are to be connected using lines and/or curves. This series of points may thus be used to define any type of shape. Processing the series of points may be done independently of the CAD software vendor that provided the input CAD marker data. The generic marker data may also include information about the characteristics of the lines/curves. For example, the thickness, background, and color. The generic marker data may also include information about the marker such as color fill and additional information to be displayed with the marker such as vendor name.

In certain embodiments, the generic marker data includes a marker object. In certain embodiments, the generic marker data includes marker data.

At step 540, a marker is drawn based on the generic marker data. The generic marker data may be the generic marker data generated at step 530, discussed above, for example. The marker may be drawn by a controller similar to the controller 340, discussed above, for example. The marker may be drawn on an image to be displayed. The marker may be drawn using a model such as the model 350 and/or the custom/free shape model 355, discussed above, for example.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments of the present invention provide a universal marker parser for drawing CAD markers by using point-to-point line/curve connections instead of an algorithm defined by a vendor. Certain embodiments eliminate vendor-specific CAD translators. Certain embodiments provide quick support for different markers from various vendors, versions, and/or regions. Certain embodiments provide savings in development time and cost. Certain embodiments allow a simplification of the workstation software application with lesser safety or major risk problems. Certain embodiments of the present invention provide technical effect of a universal marker parser for drawing CAD markers by using point-to-point line/curve connections instead of an algorithm defined by a vendor. Certain embodiments provide a technical effect of eliminating vendor-specific CAD translators. Certain embodiments provide a technical effect of quick support for different markers from various vendors, versions, and/or regions. Certain embodiments provide a technical effect of saving in development time and cost. Certain embodiments provide a technical effect of allowing a simplification of the workstation software application with lesser safety or major risk problems.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information processing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for vendor-independent computer-aided diagnosis (CAD) marker generation, the system including:
a parser adapted to parse CAD marker data into parsed data; and
a marker generator adapted to generate generic marker data based on the parsed data and a configuration file, wherein the generic marker data includes a set of point pairs.

2. The system of claim 1, wherein the CAD marker data is in Structure Reporting for Medical Evidence format.

3. The system of claim 1, wherein the CAD marker data is from at least one of:
CAD software, an analysis module on a remote server, and a vendor workstation.

4. The system of claim 1, wherein the configuration file includes rules for a plurality of CAD software vendors.

5. The system of claim 1, wherein the configuration file includes rules for a plurality of versions of CAD software for the same vendor.

6. The system of claim 1, wherein the generic marker data is a marker object.

7. The system of claim 1, wherein the generic marker data is in at least one of: XML format, comma separated values format, text format, and binary format.

8. The system of claim 1, wherein each points pair is to be connected using one of a line and a curve.

9. The system of claim 1, further including a controller adapted to draw a CAD marker on an image based on the generic marker data.

10. The system of claim 9, wherein the controller is adapted to draw the CAD marker using a free shape model.

11. A method for vendor-independent computer-aided diagnosis (CAD) marker generation, the method including:
receiving CAD marker data at a parser;
parsing the received CAD marker data into parsed data at the parser; and
generating generic marker data based on the parsed data and a configuration file at a marker generator, wherein the generic marker data includes a set of point pairs.

12. The method of claim 11, wherein the CAD marker data is in Structure Reporting for Medical Evidence format.

13. The method of claim 11, wherein the CAD marker data is from at least one of: CAD software, an analysis module on a remote server, and a vendor workstation.

14. The method of claim 11, wherein the configuration file includes rules for a plurality of CAD software vendors.

15. The method of claim 11, wherein the configuration file includes rules for a plurality of versions of CAD software for the same vendor.

16. The method of claim 11, wherein the generic marker data is a marker object.

17. The method of claim 11, wherein the generic marker data is in at least one of: XML format, comma separated values format, text format, and binary format.

18. The method of claim 11, further including drawing a CAD marker on an image based on the generic marker data.

19. The method of claim 18, wherein the drawing step includes connecting each points pair using one of a line and a curve.

20. A computer-readable medium including a set of instructions for execution on a computer, the set of instructions including:
a parser routine configured to parse CAD marker data into parsed data; and
a marker generator routine configured to generate generic marker data based on the parsed data and a configuration file, wherein the generic marker data includes a set of point pairs.
